(19) United States
(12) Patent Application Publication
(10) Pub. No.: US 2009/0191305 A1
(43) Pub. Date: Jul. 30, 2009

(54) Method of Increasing Activity

(76) Inventors: Penelope MORRIS, Waltham-on-the-Wold (GB); Rachel HACKETT, Waltham-on-the-Wold (GB); John SPEAKMAN, Aberdeen (GB); Kerry CAMERON, Aberdeen (GB)

Correspondence Address: WOODCOCK WASHBURN LLP, CIRA CENTRE, 12TH FLOOR, 2929 ARCH STREET, PHILADELPHIA, PA, 19104-2891, US

(21) Appl. No.: 12/207,716

(22) Filed: Sep. 10, 2008

(30) Foreign Application Priority Data
Sep. 11, 2007 (GB) 0717711.6

(51) Int. Cl. A23K 1/18

(52) U.S. Cl. 426/2

(57) ABSTRACT

The present invention relates to a method of increasing the physical activity of a cat, the method comprising feeding said cat a dry cat food with added water. The dry food may be in the form of kibbles.

### CROSS-REFERENCE TO RELATED APPLICATIONS

This application claims priority to Great Britain Application Number 071771 1.6 filed Sep. 11, 2007, which is incorporated herein by reference in its entirety.

### FIELD OF THE INVENTION

The present invention relates to a method of increasing the physical activity of a cat, a method of comprising feeding said cat a dry cat food with added water.

### BACKGROUND

The domestic cat (Felis silvestris catus) is a member of the order Carnivora and the Felidae is the only family within this order that are obligate carnivores. Historically, cats have been considered adept at regulating energy intake. However, whether they count the calories or volume of food ingested is debated. Additionally, it has been proposed cats have only a long term intake regulatory ability. As obesity levels are rising in the human population, the prevalence of obesity in companion animals is also increasing. In 1994, 25% of all cats in America were classed as obese and more recent estimates have risen to 35%, resulting in overweight being the most common nutritional disorder of dogs and cats in the US. Idiopathic hepatic lipidosis and diabetes mellitus are common diseases associated with an increased body mass in cats. Caloric restriction (a “diet”) is deemed a traditional and successful means of weight loss for humans and their pets. However, the long term success of any such diet is not guaranteed.

Exercise is another traditional and successful means of weight loss as well as improving the life characteristics of animals.

### SUMMARY

The present invention provides a method of increasing the physical activity of a cat, the method comprising feeding said cat a dry cat food with added liquid.

The present inventors have shown that compared to feeding the same dry cat food with ad libitum liquid on the side, a cat which is provided with the dry cat food where the liquid is added to it, has an increased physical activity. Such an increased physical activity is useful to maintain the general health of the animal as well as contributing to a means of weight loss for the animal. Furthermore, the increased activity of the animal can provide for increasing enjoyment of the pet owner/carer.

### BRIEF DESCRIPTION OF THE FIGURES

FIG. 1 is a graphical outline of the trial; and

FIG. 2 is a group of graphs representing activity levels at various dietary conditions.

### DETAILED DESCRIPTION

Dry cat food is cat food with up to 15% moisture, preferably 5 to 15% moisture. Preferably the dry cat food is in the form of kibbles. Kibbles are dry ready to eat food containing up to 15% moisture, preferably 5 to 15% moisture which are presented as small biscuits. The dry food preferably has a cooked starch component, optionally the starch component being in expanded form. The dry food may incorporate meat or animal derived material or may be meat free. The dry food may incorporate one or more types of fibre and may optionally also be a nutritionally complete foodstuff. These aspects of the dry food may be present in kibbles.

In the present invention, the cat is the domestic cat.

It is most common for dry cat food to be fed as a meal or as part of a meal. According to the present text, when the dry food is fed as part of a meal it is placed in a bowl for the cat to consume (rather than being fed piece by piece from the carer's hand). Where the dry cat food is fed as the meal, the liquid is simply added to the dish or bowl in which the food is presented to the animal. Where the dry cat food is fed as part of the meal, according to the present invention, it may be presented to the cat with all components combined together. Alternatively, the dry cat food and the liquid are added together and the other components of the meal are presented separately to the cat.

The liquid to be added to the cat food can be any liquid which the cat will consume in combination with the dry cat food. Examples of suitable liquids include soup, water, gravy or stock. In the situation where the liquid is soup, gravy or a stock, these can be flavoured such as with chicken, meat or fish if the cat enjoys such added flavour to their dry cat food. For the sake of ease of provision of a liquid, it can be water (for example from the kitchen tap). The liquid can be added to the dry cat food at room temperature or at a temperature below room temperature or above room temperature. The temperature of the added liquid may depend on its availability and the preference of the cat for a particular temperature of its meal when the liquid has been added. When the liquid has been added to the kibble, it can be mixed together, but this is not necessary. In most situations, the dry cat food will retain at least a portion of its shape and consistency during the addition of the liquid and the eating of the food by the cat.

The present invention relates to a method of increasing the physical activity of a cat where there are no apparent health problems to the cat. However, in situations where the general health or a specific health aspect of the cat can be improved by increasing the physical activity of the cat, then the method of the present invention can be described as a dry cat food with added liquid for increasing the physical activity of a cat.

All preferred aspects of the invention as described above in relation to the method of increasing the physical activity of a cat apply to the dry cat food with added liquid for increasing the physical activity of a cat.

The present invention will now be described with reference to the examples, as follows:

### EXAMPLES

### Methods

1. Subjects. Animals were housed at the Waltham Centre for Pet Nutrition (WCPN; Melton Mowbray, England). Subjects were 12 male and 7 female domestic short haired cats, and 1 female long haired cat, all were neutered (N=20). Cats were divided into 2 social rooms with 10 cats in each room and were categorised as two groups according to which room they were in. They were sex, bodyweight (range 4.4 to 6.5 kg) and age (range 2.3 to 8.9 years) matched across the two groups. Additionally, two feeding groups were created with 10 cats in each, with both groups containing 5 animals from each social room. For the purposes of dual energy x-ray absorptiometry, these groups were again subdivided into three subgroups: A, B and C. Water was available at all times in the social rooms. One cat completed the trial but was excluded from analysis as an outlier. This cat was a female cat from room, in feeding group 2 and DXA group b. The trial was 56 days long.

2. Diet and Feeding. Three different calorie dense diets were used in this study using a Whiskas Top (poultry) base which was offered dry (0% hydrated), 20% hydrated or 40% hydrated. The same batch code and best-before date of Whiskas Top was used throughout. Diets of three energy densities were created by adding or removing warm tap water from the dry kibbles. Hydrating the diets achieved different calorie densities of the diet without altering the macronutrient composition. Either 500 g or 1 kg of hydrated food was made up at each mealtime depending on the amount required at each time-point. Water was thoroughly mixed with the kibbles to ensure constant hydration and diets were made up immediately prior to the morning and afternoon feed to reduce evaporation. Evaporation rates were measured over 45 minutes in various locations and a mean taken from two separate days (evaporation of the 20 and 40% hydrated diets was 1.7% and 1.8% respectively). Diet amounts were split equally into two meals each day where feeding group 1 was fed at 9.00-9.45 am and 1.00-1.45 pm. Feeding group 2 was fed at 9.45-10.30 am and 1.45-2.30 pm. At all feeding times, cats were taken from the relevant social room and housed in an allocated lodge immediately prior to the diet being offered. In this trial a lodge was used, rather than a feeding box. Cats remained in the lodge for the full 45 minutes and returned to the relevant social room after feeding.

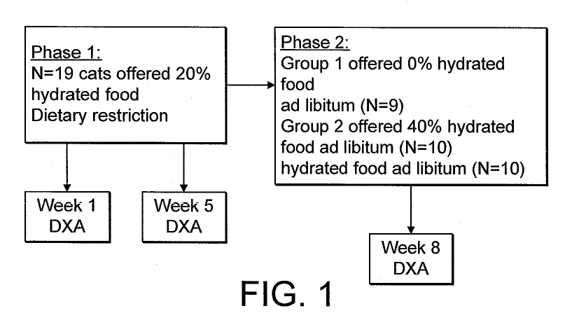

3. Outline of the trial. The trial was divided into two phases; there was no crossover (FIG. 1).

Phase 1 Dietary Restriction: Cats in both groups were fed 20% hydrated Whiskas Top for five weeks. Cats were fed 100% basic requirements each day, divided into two meals of 50%. On day 1, food intake was determined for each cat using day 1 body mass data. Cats weighing 3.5-5.5 kg were offered 50 kcal/kgBM and cats over 5.5 kg were offered 45 kcal/kgBM. Food intake was slowly reduced where amounts were changed appropriately for each cat on each weigh day (twice a week), ensuring a slow but steady rate of body mass loss over a five week period. Cats were never offered less than 30 kcal/kgBM. This intake limit was calculated relative to both their current weight and their ideal weight set by the WCPN vet at the start of the trial.

Phase 2 Trial Phase: All cats from group 1 were offered 0% hydrated food and group 2 were offered 40% hydrated food at relevant feeding times, for three weeks. Food was offered at 200% daily energy requirements, with 100% offered at each mealtime. The mass of food offered was calculated as 200% of the amount offered at the end of phase 1, calculated for each cat. Five cats consumed the entire 200% ration of either diet so intake over this phase was classed as ad libitum intake.

### 4. Measurements

4.1 Food intake and body mass. Food intake was monitored daily (±0.01 g Sartorius top pan balance, model: LP 2200P). Animals were weighed at 12-12.30 pm between the first and second meals (±1 g Sartorius balance, model: FB 34 3DE P). All cats were weighed on a Tuesday and Friday.

4.2 Body condition scoring (BCS). Cats were body condition scored according to the WALTHAM S.H.A.P.E.™ Guide at every weigh session. When a DXA day coincided with a weigh day, these cats were weighed at 12.30 pm on the day prior to scanning. Generally there were no great changes in BCS, cats only ever changed to or from grade D, E or F.

4.3 Dual energy x-ray absorptiometry (DXA4). During weeks 1 and 5 of phase 1, and week 3 of phase 2, cats were DXA scanned to assess their body composition (N=20) Groups A, B and C were scanned in turn. They were scanned on Tuesday, Wednesday and Thursday in phase 1 and on Monday, Wednesday and Friday of phase 2. Cats were offered their second meal in the afternoon of the day they were scanned so received half their daily ration. Cats were health assessed by the vet prior to the trial, prior to DXA scanning and when the trial was complete.

4.4 Activity monitoring. Two methods of monitoring the activity levels of these cats were used:

1.Actical® monitors (Mini Mitter Company, Inc. Bend, Oreg. USA). These devices are human physical activity monitors which use an internal accelerometer to assess the occurrence and intensity of motion. Acticals store information as activity counts every minute of the day. Acticals were assigned randomly and attached to the collars of 15 cats: 8 from group 1 and 7 from group 2. The monitors were on the cats for 6 continuous days in the last two weeks of phase 1 and for 12 days over the first two weeks of phase 2. Data from the first and last days, and data collected from days of DXA scanning were excluded.

2. A wooden pole was erected across the front of each social room door so hard drive video recorders (JVC: GZ-MG30E/EK) could be mounted and pointed in through the glass. Two cameras were mounted on the door of each social room, one camera pointing to the left hand side of the room, the other to the right hand side. Cameras were switched on at approximately 8.30 am and taken down the following morning. Cameras recorded continuously for 24 hours, however, no images could be seen at night and to avoid upsetting photoperiod, only activity from 8.30 am to when the room was in total darkness was studied. Windows surrounded the social rooms so cats had a light: dark cycle according to day length. Two whole days of each phase were recorded for each group. Videos were recorded on the last week of phase 1 and the second week of phase 2 when all cats had been on the relevant diet for each phase for a minimum of a week. Each video was watched back in real time and two computer screens were used thus displaying each half of the room at once. If cats were not in view, they could be sitting right in front of door, on the door ledge, or on shelves mounted above the door. If this was the case, there was not room for substantial movement so it was assumed cats were either sitting still or lying down. Cats had a ‘leg stretch’ and a ‘social’ session once a day, where they were in a room with toys on their own, then in a room with a WCPN pet carer who encouraged a range of activities for 20 minutes each day. Activities encouraged with one room were always repeated with the other. The cats from the two social rooms were always kept separate. During leg stretch and social times, one camera was removed from the door and used as a handheld camcorder by an observer sitting in the corner. Accelerometers were used to quantify levels of activity in each room and on each phase. Video footage was watched to characterise different activities and also to validate the use of Acticals in monitoring activity of domestic cats.

5. Data analysis. All statistical analysis was performed with MINITAB version 13.1. All data was normally distributed (Kolmogorov-Smirnov test). General Linear Models (GLM) considered changes in activity over time, both across each day and for each hour of the day, again considering dietary and diet-by-time interactions. In all GLM analysis, any non-significant interaction effects were removed and the analysis repeated. Then, any non-significant diet interaction or dietary effects were not reported. Significant values were taken as p≦0.05. Data are mean±standard deviation unless otherwise stated.

### Results

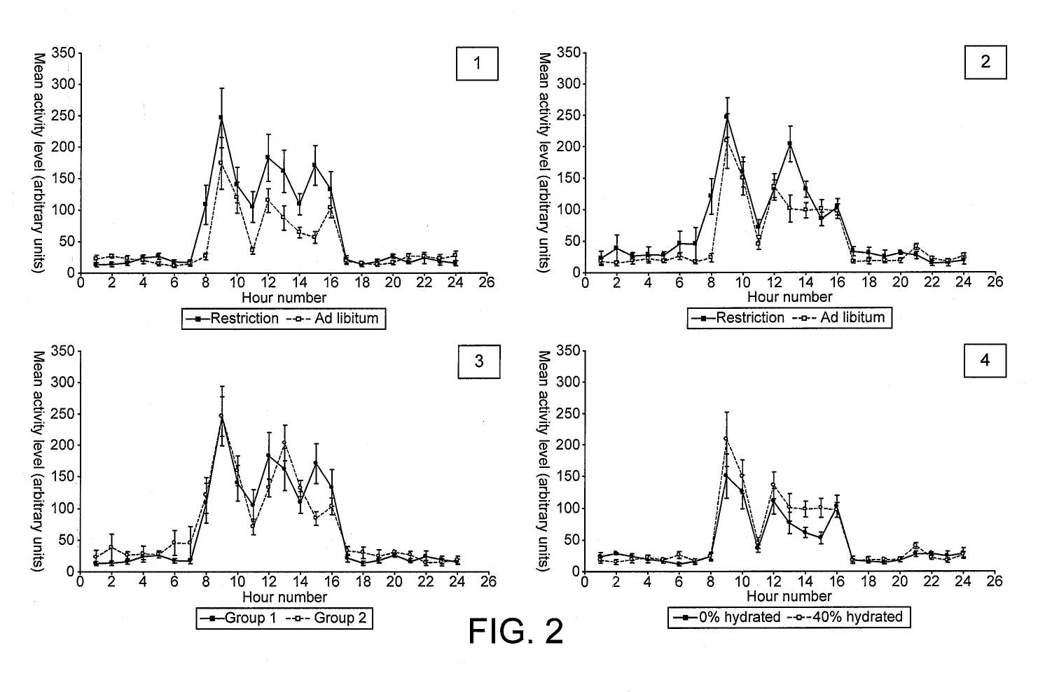

Activity monitoring. Mean activity counts from Actical monitors were taken for each hour of the day for each group (FIG. 2). Video camera data was watched back and used to validate this data. Activity in the room was assessed according to what the majority of cats were doing. Generally, all cats would tend to show the same category of behaviour:
Low levels of activity: sleeping with eyes shut and not moving, sitting down for prolonged periods (>5 minutes)
Medium levels of activity: grooming, slow walking around the room, walking and sitting intermittently and observing what is going on outside
High levels of activity: interacting with each other by playing or chasing, pacing and fast walking around the room
   Actical data showed activity levels significantly changed across each hour of the either phase (P21 0.001) where there were clear peaks in activity throughout the day. Cats had a rigid daily pattern of activity as their day was split into a timeframe set by the unit staff. Therefore, the general pattern of activity was the same over the day and levels of activity were greatest prior to feeding times, especially the first feed. Very low levels of activity were recorded at night presumably as cats slept and moved very little when there were no people on the unit. A comparison in activity levels when under dietary restriction and when ad libitum feeding within each group was first considered (FIG. 2: panels 1 and 2). Activity levels were greater over the restriction phases than the ad libitum phases, especially in group 1 (offered 0% hydrated food). Group 1 showed moderate activity levels when under restriction but low levels when ad libitum feeding. For example most cats had to be carried out the room to be fed at the second feeding time over phase 2. The disparity between the data for restriction and ad libitum feeding was not as clear for group 2 in either accelerometer or video analysis. There was more grooming and interacting such as playing and chasing when cats were under dietary restriction in both rooms, as compared to ad libitum feeding.

Activity comparisons between restriction and ad libitum feeding between the groups were then analysed (FIG. 2: panels 3 and 4). When dietary restricted, there was no difference in activity levels between the groups (P=0.740). When cats were offered ad libitum food intake, there was significantly more activity (offered 40% hydrated food) than group 1 (offered 0% hydrated food) when ad libitum feeding (P=0.030). From video analysis, activity patterns were similar in the two groups when under dietary restriction. In general, activity levels were moderate over the restriction phase and both groups were active during socialisation periods, particularly if encouraged by the pet carer. When ad libitum feeding, the disparity between the two groups was very clear as group 1 spent the majority of the day sleeping. In comparison, activity levels were noticeably greater in group 2 cats; they were active all day, walking and pacing the floor and did not settle into beds until people had left the unit at the end of the day. Also, when socialising with the carer or during the leg stretch, they tended to explore and play more than group 1 who just sat down on their own if not interacting with the carer. By observation, activity levels were similar, sometimes greater than the restriction phase for group 2. Additionally, there were a greater number of ‘active’ cats in group 2 despite the groups being age matched (mean age of 4.9 years in group 1 and 4.0 in group 2). Actical data was recorded for a number of days across each phase, but there was no day effect when restriction feeding (P=0.576) with no diet effect (P=0.799). There was also no day effect across ad libitum feeding (P=0.087) but a significant diet (P<0.001) effect where cats consuming 40% hydrated food had higher activity levels than those consuming 0% hydrated food. Individual accelerometer data also illustrated which cats were the most active/inactive, which correlated well with visual analysis. Generally, if they were inactive/active during restriction, they showed a similar pattern over ad libitum feeding (R²=0.6249) (figures not shown).

### Discussion

Indirect measures of energy expenditure were carried out by activity monitoring using Actical accelerometers and video playback visual analysis. Acticals have only been used in human studies (e.g. Pfeiffer, K. A., McIver, K. L., Dowda, M., Almeida, M. J., Pate, R. R. Validation and calibration of the Actical accelerometer in preschool children. Med. Sci. Sports Exerc. 2006;38(1): 152-7) but were found to be a very successful means of gaining activity counts in domestic cats. The values correlated well with what was actually occurring from video footage, and was successfully used with all cats apart from one who persistently removed the monitor from the collar. Considering each day of accelerometer data, activity levels were consistent suggesting activity stayed the same throughout the length of the phase. Activity levels were greater when cats were dietary restricted which is a commonly occurring phenomenon, shown particularly by wheel running rodent models. In the wild, this may translate as animals hunting for more food, but as WCPN cats are fed by staff, hunting behaviours were not easily observed and may not be found in domesticated animals that do not go outdoors such as these. An animal behaviourist may have been able to spot specific hunting behaviours not easily noticed by the amateur eye. However, similar behaviours to those prior to set meals times such as sitting at the door and pacing around the door were observed by this group. When ad libitum feeding, all cats reduced activity levels, and continuing along the same logic, they did not require high levels of foraging behaviour as were consuming enough food to maintain body mass. There was a significant difference in the amount of activity expended between the ad libitum conditions, where the group consuming 40% hydrated food moved around considerably more than cats consuming 0% hydrated food.

1. A method of increasing the physical activity of a cat, the method comprising the step of feeding said cat a dry cat food with added water.

2. The method as claimed in claim 1, wherein the dry food is in the form of kibbles.

3. The method as claimed in claim 1, wherein the dry food is fed as a meal or as part of a meal.

4. The method as claimed in claim 2, wherein the dry food is fed as a meal or as part of a meal.

5. The method as claimed in claim 1, wherein the liquid is soup, water, gravy or stock.

6. The method as claimed in claim 2, wherein the liquid is soup, water, gravy or stock.

7. The method as claimed in claim 3, wherein the liquid is soup, water, gravy or stock.
